(19) United States
(12) Patent Application Publication
(10) Pub. No.: US 2003/0138570 A1
(43) Pub. Date: Jul. 24, 2003

(54) Method to prepare diagnostic films using engraved printing cylinders such as rotogravure

(75) Inventors: Rosann Kaylor, Cumming, GA (US); Stephen Quirk, Alpharetta, GA (US); Chibueze O. Chidebelu-Eze, Atlanta, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/026,069

(22) Filed: Dec. 21, 2001

(51) Int. Cl. B05D 1/28; B05D 5/00; B05D 3/02

(52) U.S. Cl. 427/428; 427/256; 427/372.2

(57) ABSTRACT

The present invention provides a simple, reliable, and inexpensive process for the manufacture of diagnostic biosensor films such as diffraction-based diagnostic films. The present invention includes a method for preparing a diffraction-based diagnostic biosensor film that includes the steps of: a) providing a receptor solution that includes a receptor and a carrier fluid, b) applying the receptor solution to a printing cylinder having a longitudinal axis and an engraved pattern of cells, each cell having a width, height, and depth for acceptance of the receptor solution, the printing cylinder being rotated about the longitudinal axis, c) transferring the receptor solution from the rotating printing cylinder to a substrate, and, d) drying the printed substrate, wherein the dried receptor forms a pattern that includes individual printed areas having a center-to-center spacing ranging from about 0.1 microns to about 100 microns.

### FIELD OF THE INVENTION

The present invention generally relates to the preparation and manufacture of diagnostic films.

### BACKGROUND OF THE INVENTION

There are many systems and devices generally known as biosensors available for detecting a wide variety of analytes in various media. Examples include fluorescence-based, surface plasmon resonance-based, electrochemical-based, and diffraction-based biosensors. A particular example is a diffraction-based biosensor having a diagnostic film that, upon exposure to specific analytes, generates a visible diffraction pattern when exposed to a light source. Diffraction-based diagnostic films offer a simple and reliable method for detecting the presence of specific analytes. However, there exists a need for a reliable and inexpensive process to manufacture such diffraction-based diagnostic films.

As an example, U.S. Pat. No. 6,048,623 to Everhart et al. describes a metalized film upon which is printed a predetermined pattern of analyte-specific receptor. Upon attachment of a target analyte to the printed receptor, diffraction of transmitted and/or reflected light occurs via the physical dimensions, refractive index and precise placement of the receptor/analyte combination. Formation of the diffraction pattern therefore indicates the presence of the analyte in the medium being tested.

U.S. Pat. No. 6,048,623 also discloses methods to prepare diffraction-based diagnostic films that focus on contact printing. Specifically, a patterned elastomeric stamp can be used to apply the receptor “ink” to a metalized surface. However, the use of elastomeric stamps lends itself more to small batch processing than it does to large scale manufacturing of diffraction-based diagnostic films.

U.S. Pat. No. 6,048,623 also discloses a material that is suitable for continuous, rather than batch, fabrication. However, it does not disclose the details of how this continuous fabrication is to be accomplished. In this regard, there is little known about gravure printing of protein receptors. A journal article entitled “Protein-Pigment Interactions for Controlled Rotogravure Printing Properties” (Tappi J. (1984), 67(5), 60-4)) discusses the study of protein-pigment interactions for rotogravure printability of coated paper. Others describe the use of proteins to enhance flexographic printing. However, none of these references disclosed the protein as the desired “ink”. Rather, the protein was used as a functional additive, for example as a means to prevent clogging of printing plates.

Thus, there remains a need for a simple, reliable, and inexpensive process to manufacture diagnostic biosensor films such as diffraction-based diagnostic films.

### SUMMARY OF THE INVENTION

The present invention provides a simple, reliable, and inexpensive process for the manufacture of diagnostic biosensor films such as diffraction-based diagnostic films. The present invention includes a method for preparing a diffraction-based diagnostic biosensor film that comprises the steps of: a) providing a receptor solution that comprises a receptor and a carrier fluid, b) applying the receptor solution to a printing cylinder having a longitudinal axis and an engraved pattern of cells, each cell having a width, height, and depth for acceptance of the receptor solution, the printing cylinder being rotated about the longitudinal axis, c) transferring the receptor solution from the rotating printing cylinder to a substrate, and, d) drying the printed substrate, wherein the dried receptor forms a pattern that comprises individual printed areas having a center-to-center spacing ranging from about 0.1 microns to about 100 microns.

Examples of receptors suitable for the present invention include, but are not limited to, proteins, antibodies, nucleic acids, peptides, small organic molecules and combinations thereof. Examples of carrier fluids suitable for the present invention include, but are not limited to, water, aqueous buffer solution, phosphate buffered saline, and combinations thereof.

The receptor solution of the present invention may have a viscosity less than about 10 centipoise, or alternatively, may have a viscosity less than about 2 centipoise. The receptor solution of the present invention may further comprise receptor at a concentration of at least 0.1 mg/ml. The receptor solution of the present invention may further comprise a flow modifier such as glycerol.

In one embodiment of the present invention only a fraction of the receptor solution within a cell is transferred from the rotating printing cylinder to the substrate.

The substrate of the present invention may comprise a thermoplastic film. The substrate of the present invention may further comprise a metal coating. In one embodiment of the present invention the metal coating comprises gold. In another embodiment of the present invention the receptor solution is applied to the metal coating of a thermoplastic film.

The method of the present invention may further comprise the step of applying surface treatment to the substrate prior to transferring the receptor solution from the rotating printing cylinder to the substrate. Examples of surface treatments that may be applied to the substrate include, but are not limited to, surfactants, Corona discharge, proteins (including, but not limited to, beta-caseine), and combinations thereof.

The method of the present invention may further comprise the step of directing a stream of air at the surface of the rotating printing cylinder prior to application of the receptor solution to the substrate. In another embodiment, the method of the present invention may further comprise the step of rinsing the printed substrate prior to drying the printed substrate. In a further embodiment of the present invention, the drying step may further comprise air drying of the receptor solution on the printed substrate at ambient conditions.

In the method of the present invention, the individual printed areas forming the pattern may have a center-to-center spacing ranging from about 10 microns to about 75 microns.

In an embodiment of the present invention, the individual printed areas forming the pattern may measure from about 0.1 microns across to about 70 microns across. In another embodiment of the present invention, the individual printed areas forming the pattern may measure from about 1 micron across to about 50 microns across.

In an embodiment of the present invention, the contact angle of the receptor solution with respect to the surface of the substrate is less than the contact angle of the receptor solution with respect to the surface of the gravure cylinder. In another embodiment of the present invention, the contact angle of the receptor solution with respect to the surface of the substrate is from about 5° to about 90°. In a further embodiment of the present invention, the contact angle of the receptor solution with respect to the surface of the substrate is from about 10° to about 80°. In another particular embodiment of the present invention, the contact angle of the receptor solution with respect to the surface of the substrate is from about 30° to about 70°.

The present invention also includes the diffraction-based biosensor film made according to the method for preparing a diffraction-based diagnostic biosensor film that comprises the steps of: a) providing a receptor solution that comprises a receptor and a carrier fluid, b) applying the receptor solution to a printing cylinder having a longitudinal axis and an engraved pattern of cells, each cell having a width, height, and depth for acceptance of the receptor solution, the printing cylinder being rotated about the longitudinal axis, c) transferring the receptor solution from the rotating printing cylinder to a substrate, and, d) drying the printed substrate, wherein the dried receptor forms a pattern that comprises individual printed areas having a center-to-center spacing ranging from about 0.1 microns to about 100 microns.

Additionally, the present invention includes a method for preparing a diagnostic biosensor film comprising the steps of: a) providing a receptor solution comprising a receptor and a carrier fluid, b) applying the receptor solution to a printing cylinder having a longitudinal axis and an engraved pattern of cells, each cell having a width, height, and depth for acceptance of the receptor solution, the printing cylinder being rotated about the longitudinal axis, c) transferring the receptor solution from the rotating printing cylinder to a substrate, and, d) drying the printed substrate.

The present invention further includes the diagnostic biosensor film made according to the method for preparing a diagnostic biosensor film comprising the steps of: a) providing a receptor solution comprising a receptor and a carrier fluid, b) applying the receptor solution to a printing cylinder having a longitudinal axis and an engraved pattern of cells, each cell having a width, height, and depth for acceptance of the receptor solution, the printing cylinder being rotated about the longitudinal axis, c) transferring the receptor solution from the rotating printing cylinder to a substrate, and, d) drying the printed substrate.

These and other features and advantages of the present invention will become apparent after a review of the following detailed description of the disclosed embodiments.

### BRIEF DESCRIPTION OF THE DRAWINGS

FIG. 1 is a schematic view of a rotogravure printing unit, illustrating an exemplary rotogravure printing process.

FIG. 2 is a schematic view of a rotogravure printing unit, illustrating an exemplary rotogravure printing process.

FIG. 3 is a photomicrograph of an open cell pattern engraved in a rotogravure cylinder.

FIG. 4 is a photomicrograph of a closed cell pattern engraved in a rotogravure cylinder.

FIG. 5 is a photomicrograph of the surface of gravure printed diffraction-based diagnostic film Sample No. 8 after being subjected to the enzyme-based test for diffraction.

FIG. 6 is a photomicrograph of the surface of a gravure printed diffraction-based diagnostic film Sample No. 18 after being subjected to the enzyme-based test for diffraction.

FIG. 7 is a photomicrograph of the surface of a gravure printed diffraction-based diagnostic film Sample No. 18 after being subjected to the enzyme-based test for diffraction.

FIG. 8 is a photomicrograph of the surface of a gravure printed diffraction-based diagnostic film Sample No. 25 after being subjected to the enzyme-based test for diffraction.

FIG. 9 is a photomicrograph of the diffraction pattern generated by exposure of Sample No. 23 to laser light.

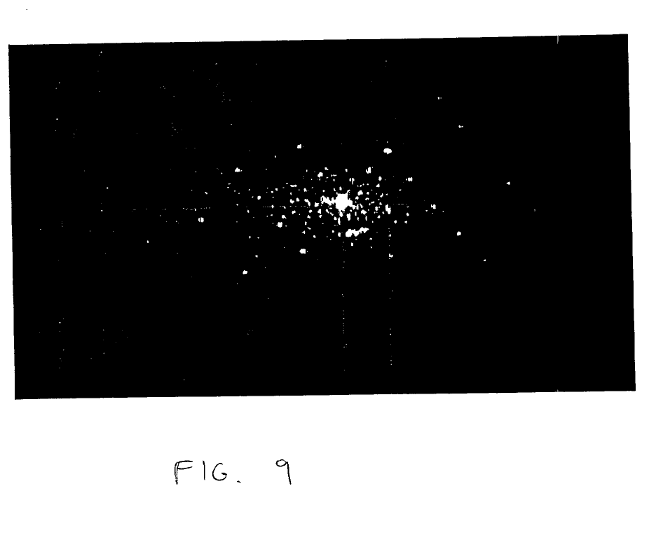

### DETAILED DESCRIPTION

The present invention is directed to gravure printing of analyte-specific receptors onto a film substrate that allows for the development of single-use, disposable biosensors. Examples of biosensors utilizing analyte-specific receptors that may be produced by the methods of the present invention include diffraction-based, fluorescence-based, surface plasmon resonance-based, and electrochemical-based analyte detection sensors. As a particular example, the gravure printed films of the present invention are suitable for use with light diffraction biosensors such as those described in U.S. Pat. Nos. 5,922,550, 6,020,047, 6,048,623, 6,060256, 6,180,288, and 6,221,579, the entire contents of which are incorporated herein by reference. As an additional example, the gravure printed films of the present invention are suitable with biosensors such as those described in the commonly owned patent application entitled “SENSORS AND METHODS OF DETECTION FOR PROTEINASE ENZYMES” to Stephen Quirk et. al. filed Dec. 21, 2001 under Express Mail number EL602999586US, the entire contents of which are incorporated herein by reference.

In diffraction-based analyte detection sensors, upon attachment of a target analyte to select areas of the substrate film that contain the receptor, diffraction of transmitted and/or reflected light occurs via the physical dimensions and defined, precise placement of the analyte. By way of example only, yeast, fungi, protozoa or bacterium are large enough to act as diffraction elements for visible light when placed in organized patterns on a surface. In addition to producing a simple diffraction image, patterns of analytes can be such as to allow for the development of a holographic sensing image and/or a change in visible color. Thus, the appearance of a hologram or a change in an existing hologram will indicate a positive response. The pattern made by the diffraction of the transmitted or reflected light can be any shape including, but not limited to, the transformation of a pattern from one pattern to another upon binding of the analyte to the receptive material. The diffraction grating that produces the diffraction of light upon interaction with the analyte must have a minimum periodicity of ½ the wavelength and a refractive index different from that of the surrounding medium or a height from the substrate surface higher than that of the surrounding substrate. A desirable center-to-center spacing ranges from about 0.1 microns to about 100 microns and more desirably from about 10 microns to about 75 microns. The individual areas that make up the pattern are desirably from about 0.1 microns across to about 70 microns across and more desirably from about 1 micron across to about 50 microns across. A diffraction pattern is also generated even if the individual areas extend into each other as long as there remains a pattern of areas that are not printed.

Any film upon which the receptor can be deposited and affixed is a suitable substrate for the present invention. As a particular example, metal-coated plastic films are suitable for use with the present invention. Exemplary films include, but are not limited to, polymers such as: polyethylene-terephthalate (PET), acrylonitrile-butadiene-styrene, acrylonitrile-methyl acrylate copolymer, cellophane, cellulosic polymers such as ethyl cellulose, cellulose acetate, cellulose acetate butyrate, cellulose propionate, cellulose triacetate, cellulose triacetate, polyethylene, polyethylene-vinyl acetate copolymers, ionomers (ethylene polymers) polyethylene-nylon copolymers, polypropylene, methyl pentene polymers, polyvinyl fluoride, aromatic polysulfones, and glasses. Other suitable thermoplastic polymers and suppliers may be found, for example, in reference works such as the Modem Plastics Encyclopedia (McGraw-Hill Publishing Co., New York 1923-1996).

By way of example only, metals suitable for film deposition include gold, silver, aluminum, chromium, copper, iron, zirconium, platinum, nickel and so forth. Additionally, oxides of these metals such as, for example, chromium oxide and gold oxide are also suitable for use with the present invention.

The diffraction patterns generated from the diagnostic films of the present invention may be produced by reflected light, transmitted light, or both. In one embodiment of the invention wherein the diffraction pattern is produced by transmitted light, the thermoplastic film with the metal coating thereon has an optical transparency of between about 5% and about 95%. Another desired optical transparency for the metal-coated thermoplastic film used in the present invention that allows the diffraction pattern to be generated by both reflected and transmitted light is between about 20% and about 80%. In another desired embodiment of the present invention, the thermoplastic film has at least about 80% optical transparency, and the thickness of the metal coating is such as to maintain an optical transparency greater than about 20%, so that diffraction patterns can be produced by either reflected or transmitted light. When gold is the metal coating, this corresponds to a metal coating thickness of about 20 nanometers. However, in other embodiments of the invention, the metal thickness may be between about 1 nanometer and about 1000 nanometers.

The present invention includes a receptor that is gravure-printed on a substrate, for example, a metalized film or other attachment layer. The receptor is chosen such that it will specifically and selectively bind to the analyte of interest. The receptor that is bound to the attachment layer is characterized by an ability to specifically bind the analyte or analytes of interest. Only the types of material that will combine selectively with a binding partner (with respect to any chosen sample) limit the variety of materials that can be used as the receptor. Examples of materials in the overall class of receptors include, but are not limited to, toxins, antibodies, antigens, hormone receptors, parasites, cells, haptens, metabolites, allergens, nucleic acids, nuclear materials, autoantibodies, cellular debris, enzymes, enzyme substrates, coenzymes, neuron transmitters, viruses, viral particles, microorganisms, proteins (including, but not limited to, blood and tissue proteins), saccharides, chelators, drugs, and so forth. Thus, the receptor is one part of a specific binding pair that includes the receptor and the specific analyte that binds thereto. Examples of analyte/receptor binding pairs include, but are not limited to, antigen/antibody, antibody/antibody-binding protein (for example, Protein A or Protein G), enzyme/substrate, oligonucleotide/DNA, chelator/metal, enzyme/inhibitor, bacteria/receptor, virus/receptor (for example, Influenza A/anti-Influenza A antibodies), fungus/receptor, fungus/anti-Aspergillus antibody, cellular toxin/receptor, hormone/receptor, DNA/RNA, RNA/RNA, oligonucleotide/RNA, and binding of these species to any other species, as well as the interaction of these species with inorganic species. This list only identifies some of the many different materials that can be used as a receptor to produce a diagnostic film assay system. Whatever the selected analyte of interest is, the receptor is designed to bind specifically and selectively with the analyte of interest.

The analytes that are contemplated as being detected using the present invention include, but are not limited to, bacteria (including, but not limited to, Hemophilis, Neisseria meningitides serogroups A, B, C, Y and W135, Streptococcus pneumoniae, Salmonella species, Candida species, including, but not limited to, Candida albicans and Candida tropicalis, and E. coli K1), yeasts, fungi, antibodies (including, but not limited to, IgG, IgM, IgA, IgD and IgE antibodies), viruses (including, but not limited to, Haemophilus influenza type B or RSV, human papilloma virus (HPV), and HTLV), host response (antibodies) to these and other viruses, rheumatoid factor, antigens (including, but not limited to, cancer-specific antigens, carcinoembryonic antigen, Streptococcus Group A antigen, viral antigens, fungal antigens, antigens associated with autoimmune diseases and influenza, allergens (including, but not limited to, pollens such as tree, grass and ragweed pollen, molds, cat and dog dander, dust mites, and food products such as egg and milk), tumor antigens, streptococcus Group B antigen, HIV I or HIV II antigen, antigens specific to RSV, antigens derived from microorganisms, and antigens specific to Hepatitis), host response (antibodies) to these and other antigens, enzymes (such as plasma neutrophil elastase), hormones, saccharides, proteins (such as C-reactive protein (CRP), procalcitonin, and eosinophil-based proteins such as eosinophilic cationic protein (ECP), eosinophil neutrotoxin or major basic protein), lipids, carbohydrates, drugs of abuse and therapeutic drugs, nucleic acids, haptens, environmental agents, immunocalins such as human neutrophil lipocalin (HNL), cytokines and associated materials, such as IL-4, IL-6 or IL-2R (soluble receptor of IL-2), histamine, leukotrienes, lysozymes, myeloperoxidase, elastase, tryptase, endothelin, sexually transmitted disease antigens or organisms, trichomonas, protozoa, and so forth. A listing of suppliers and a listing of various antibodies that are commercially available are provided in Linscott's Directory. Examples of pairings of specific receptors and specific analytes or specific classes of analytes that can be detected via the use of a specific receptor are known to persons skilled in the art and can be obtained from various sources including Linscott's Directory which is hereby incorporated by reference.

One embodiment in which a small analyte can be detected entails coating a particle, such as a bead, with a receptor that will specifically bind to the analyte of interest. Particles that can be used in the present invention include, but are not limited to, glass, cellulose, synthetic polymers or plastics, latex, polystyrene, polycarbonate, proteins, bacterial cells, fungal cells, metallic sols (including, but not limited to gold or silver sols), and the like. The particles are desirably spherical in shape, but the structural and spatial configuration of the particles is not critical to the present invention. For instance, the particles could be slivers, ellipsoids, cubes, spheroids, and the like. A desirable particle size ranges from a diameter of about 0.1 microns to about 50.0 microns, desirably between about 0.2 microns to about 1 micron. To generate a diffraction pattern, the attachment of the particles must result in a refractive index different from that of the surrounding medium and/or a height above the substrate surface that is higher than the areas of the substrate where there are no particles. The composition of the particle is not critical to the present invention.

To utilize the particles, the receptor that is gravure printed on the substrate must specifically bind to an epitope on the analyte that is different from the epitope used in the binding to the particle. Thus, for detecting a small analyte, the medium is first exposed to the particles to which the small analyte binds. Thereafter, the particles are optionally washed and then exposed to the substrate with the receptor. The receptor then binds to the small analyte that is already attached to the particle, thereby immobilizing the particles in the same pattern as the receptor on the film. Because the bound particles will cause diffraction of the visible light, a diffraction pattern is formed, indicating the presence of the small analyte in the medium. Alternatively, the small analyte may be first exposed to the diagnostic film, followed by exposure of the diagnostic film to the particles. In another embodiment, simultaneous exposure of the gravure-printed diagnostic film to both the particles and the analyte will result in the analyte binding to both the receptor on the diagnostic film and the receptor on the particle. Virus particles are an example of a small analyte that can be detected using particles, and other combinations using particles are well known to those of ordinary skill in the art.

In another embodiment of the present invention, nutrients for a specific class of microorganisms can be incorporated into the patterned receptor. In this way, very low concentrations of microorganisms can be detected by first contacting the diagnostic film of the present invention with the nutrients incorporated therein and then incubating the diagnostic film under conditions appropriate for the growth of the bound microorganism. The microorganism is allowed to grow until there are enough organisms to form a diffraction pattern. Of course, in some cases, the microorganism can multiply enough to form a diffraction pattern without the presence of a nutrient in the patterned receptor. As a specific example, sugars may be printed on the substrate as a receptor to which yeasts will attach and grow. Other examples are provided in U.S. Pat. No. 5,922,550.

In this invention, the receptor is printed onto the substrate via a receptor solution using a gravure process. In the gravure process, the receptor solution is transferred from a gravure cylinder to the substrate. The receptor solution serves as a carrier for the receptor throughout the process of applying the receptor to the substrate. In preparing the receptor solution, the receptor is suspended in a suitable carrier fluid that does not alter the ability of the receptor to bind to both the substrate and the analyte. For example, phosphate buffered saline solution is suitable as a carrier fluid for many proteins that are suitable receptors for the present invention. In this invention, the receptor may be added to the carrier fluid at a level of from about 0.1 mg/ml or less to about 30 mg/ml or more to provide sufficient coverage of the receptor on the substrate. In another particular embodiment, a range of from about 0.3 mg/ml to about 3.0 mg/ml of receptor is added to the carrier fluid to form the receptor solution.

A stabilizing solution may be added to the receptor solution to increase the shelf life of the receptor solution and to provide stability to the printed receptor once it has been immobilized on the substrate. Representative stabilizing solution ingredients include, but are not limited to, sucrose, trehalose, saccharides, proteins, and so forth. Effective stabilizing solutions include, but are not limited to, STABILGUARD produced by Surmodics, Inc. of Eden Prairie, Minn. or protein free blocking and stabilizing solution (sold as STABILCOAT by Surmodics, Inc. of Eden Prairie, Minn.).

A flow modifier may be added to the receptor solution to facilitate transfer of the receptor solution to the substrate from the gravure cylinder. The flow modifier may additionally alter spreading of the receptor solution on the surface of the substrate after the receptor solution is applied to the substrate in the gravure process and provide further stabilization of the protein receptor. For example, glycerol is suitable as a flow modifier for the present invention. Glycerol at a level of from about 0 volume % to about 30 volume % may be effective to provide good solution transfer from the gravure cylinder to the substrate and maintain the requisite pattern for diffraction. More preferably, a range of from about 0.5 volume % to about 3.0 volume % glycerol is added to the receptor solution. In one embodiment, the receptor solution has a viscosity less than about 10 centipoise. In another embodiment, the receptor solution has a viscosity less than about 2 centipoise. In a further embodiment, the receptor solution has a viscosity of about 1 centipoise. Other examples of flow modifiers that may be added to the receptor solution include, but are not limited to, polyvinyl alcohol (PVOH), polyethylene glycol (PEG), polyethylene oxide (PEO), polyvinyl pyrrolidone (PVP), polyesters, polyamines, and other viscosity modifiers.

A surface-active agent may be added to the receptor solution to raise or lower the surface tension of the receptor solution and facilitate transfer of the receptor solution to the substrate from the gravure cylinder. The lower the contact angle that the receptor solution forms with respect to the surface of the substrate, the greater is the tendency for the receptor solution to spread across the surface of the substrate. To get efficient and/or substantial transfer of the receptor solution from the gravure cylinder, the contact angle of the receptor solution with respect to the surface of the substrate is desirably less than the contact angle of the receptor solution with respect to the surface of the gravure cylinder so that the receptor solution will have a preference for the substrate over the gravure cylinder. An exemplary contact angle of the receptor solution with respect to the surface of the substrate is from about 5° to about 90°. In a particular embodiment, the contact angle is from about 10° about 80°. In another embodiment, the contact angle is in the range from about 30° to about 70°. To enhance preservation of the receptor pattern on the substrate, the contact angles of the receptor solution with respect to the surfaces of the substrate and the gravure cylinder may be balanced such that the receptor solution will transfer from the gravure cylinder to the substrate, yet not wet out the substrate such that the pattern on the substrate surface would be destroyed.

Optionally, a surface treatment is applied to the substrate to increase the surface energy and facilitate the transfer of the receptor solution from the rotogravure cylinder to the substrate. Exemplary surface treatments include surface-active agents such as non-ionic surfactants, ionic surfactants or certain proteins. Additionally, the use of Corona discharge or plasma treatment to increase wettability of the substrate improves receptor solution transfer for certain substrates and receptor solutions. As a particular example, Corona treatment that gave 50-56 dynes surface energy for a gold-coated PET film was suitable for printability with a 0.3-0.5 mg/ml protein in a phosphate buffered saline solution. Additionally, or alternatively, a surface treatment can be applied to the gravure cylinder to modify the contact angle that the receptor solution forms with respect to the surface of the gravure cylinder. Examples of gravure cylinder surface treatments include, but are not limited to, chrome, ceramic, titanium, or copper coatings on the gravure cylinder. Subsequent chemical treatments including, but not limited to, release agents could also be applied to the gravure cylinder to facilitate the transfer of the receptor solution from the rotogravure cylinder to the substrate.

In some instances, a “blocker” may be applied to the substrate by the gravure process to create the pattern that will generate the diffraction pattern. A “blocker” is a reagent that adheres to the sensor surface so that it “blocks” or prevents analytes and/or nonanalytes from non-specifically binding to the surface of the sensor in areas other than where the receptors are located. An example would be to take a substrate that is already coated or gravure printed with receptor and print the blocker on the substrate such that a pattern of receptor and/or blocker remains after the printing process. Alternatively, blockers can be coated and/or printed onto the substrate prior to application of a receptor solution. Blockers can include, but are not limited to, β-casein, albumins such as bovine serum albumin, pluronic or other surfactants, polyethylene glycol, polyvinyl pyrrolidone, polyvinyl alcohol, or sulfur derivatives of the above compounds, and any other blocking material known to those of ordinary skill in the art.

Components of the gravure process typically include an engraved printing cylinder that rotates about its longitudinal axis, a receptor solution supply, a doctor blade, an impression roller, and a substrate. The process generally involves the preparation of the receptor solution, the transfer of the receptor solution to the engraved cylinder, the wiping of excess receptor solution from the engraved cylinder with the doctor blade, and the subsequent transfer of the retained receptor solution to the substrate as the substrate passes between the engraved cylinder and the impression roller. A post-printing drying step may be utilized to remove volatile components from the receptor solution. In one embodiment of the invention, air drying at ambient conditions is sufficient to dry the receptor solution. Optionally, a rinse step may be included prior to the drying step.

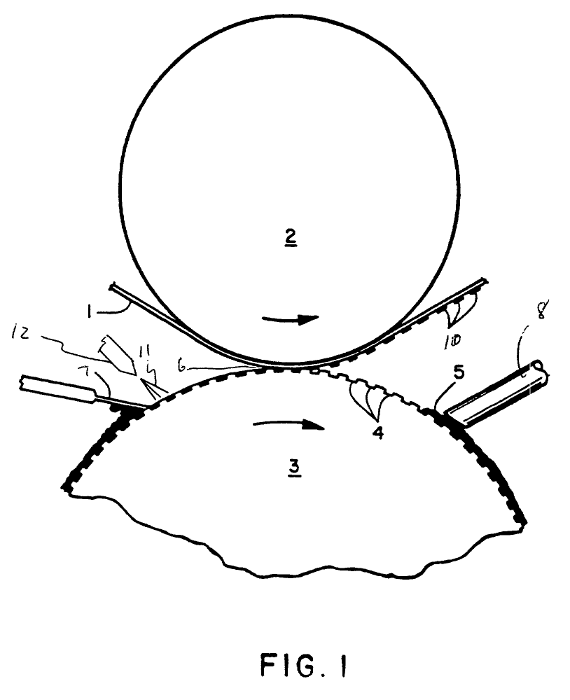

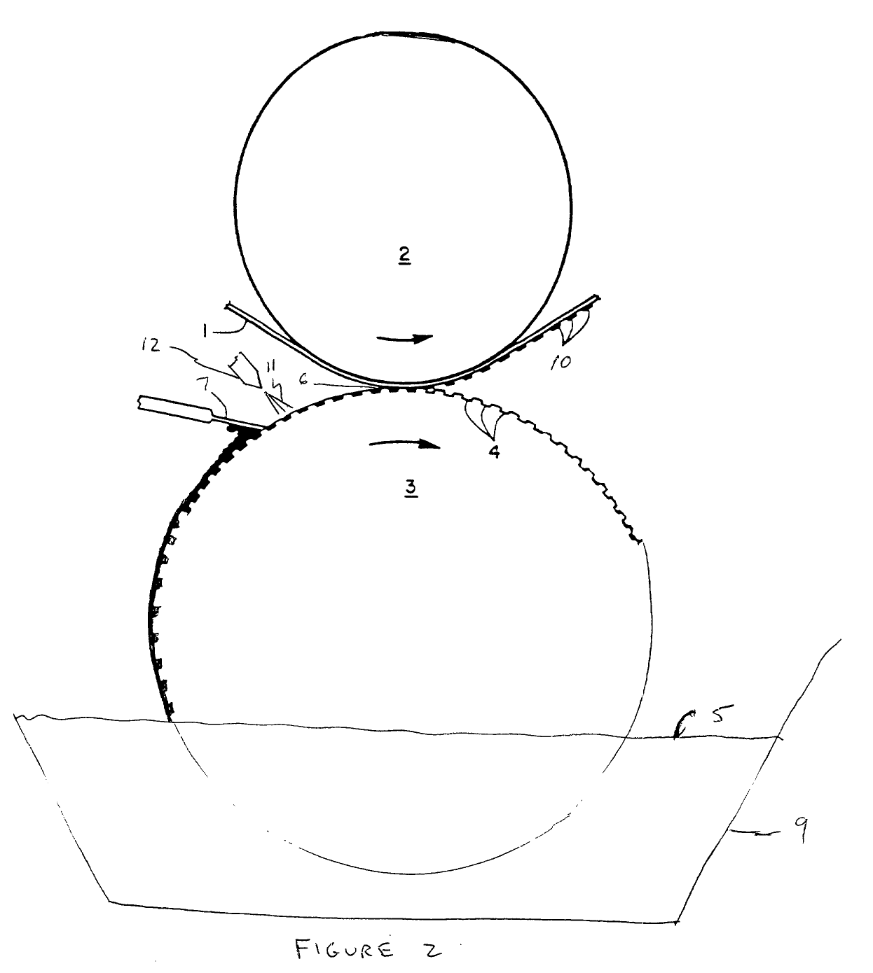

FIG. 1 and FIG. 2 are schematic diagrams of rotogravure printing units useful in the method of this invention. Shown in each figure is a substrate 1 passing between an impression roller 2 and an engraved gravure cylinder 3. The surface of the gravure cylinder 3 contains a large number of engraved depressions or cells 4, each having a width, height, and depth, which are designed to receive, hold, and transfer receptor solution 5 to the substrate 1. Receptor solution 5 is applied to the surface of the gravure cylinder 3 downstream of the nip 6 formed between the gravure cylinder 3 and the impression roller 2 and is removed from the land areas of the gravure cylinder 3 with a doctor blade 7. FIG. 1 illustrates a solution application method where the receptor solution 5 is sprayed on the engraved cylinder 3 from a sprayer 8. FIG. 2 illustrates a receptor solution application method where the engraved cylinder 3 is submerged in a basin 9 containing the receptor solution 5. As the substrate 1 enters the nip 6 between the gravure cylinder 3 and the impression roller 2, it is pressed against the gravure cylinder 3 by the impression roller 2, thereby permitting the receptor solution 5 to transfer from the gravure cylinder cells 4 and be deposited on the surface of the substrate 1 in areas 10 corresponding to the individual gravure cylinder cells 4. Optionally, a steady flow of air 11 may be directed from a nozzle 12 against the gravure cylinder 3 between the doctor blade 7 and the nip 6 prior to the transfer of the receptor solution 5 to the substrate 1. While two particular gravure processes have been shown and described, still other gravure processes and equipment are suitable for use with the present invention. As an example, indirect transfer, a process utilizing a third cylinder whereby receptor solution may be transferred to the third cylinder before being transferred to the substrate, is suitable for use with the present invention.

When printing with receptor solutions, the overall pattern of small areas on the engraved gravure cylinder remains intact in the final product. In some instances, the percentage of the surface area of the substrate covered by the receptor solution may closely match the percentage of the surface area of the gravure cylinder covered by the gravure cells. In other instances, the percentage of the surface area of the substrate covered by the receptor solution may be less than the percentage of the surface area of the gravure cylinder covered by the gravure cells. However, this relationship may not hold when using receptor solutions that have a greater tendency to migrate. Nevertheless, increase or decrease in the printed surface area can be tolerated as long as the receptor areas that result on the surface of the substrate are of proper size and spacing to generate a diffraction pattern after exposure to the analyte and upon exposure to light.

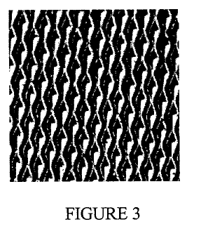

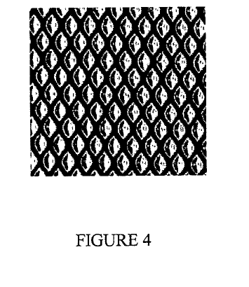

The desired rotogravure cell size, shape, and the number of cells per square inch will depend on a number of factors, including the flow characteristics of the receptor solution, surface energy of the engraved printing cylinder, surface energy of the substrate, and the desired size of the receptor areas in the pattern on the substrate. Rotogravure cylinders engraved with cell spacing ranging from 100 to 200 or more lines of cells per centimeter (lpc) may be used to print diffraction-based diagnostic films. Preferably, a cell spacing of about 140 to about 160 lpc may be used. These dimensions correspond to cell center-to-center distances of about 50 microns or less to about 100 microns. Successful transfer may be achieved with both channeled cell (see FIG. 3) and closed cell (see FIG. 4) configurations.

The doctor blade can be made of any material sufficient to remove the excess receptor solution from the surface of the gravure cylinder. Materials from which the doctor blade can be made include, but are not limited to, metal, such as stainless steel, plastic, such as Teflon, or ceramic. The doctor blade may, for example, be pivot-based with an air cylinder to provide pressure against the gravure cylinder that allows for adjustment of the pressure to minimize smearing of the receptor solution on the land areas between the gravure cylinder cells.

The impression roller desirably comprises a resilient material such as, for example, rubber and desirably has a hardness of about 90 Shore A durometer or less, preferably about 70. The loading between the impression roller and the gravure cylinder should be low enough to avoid permanent distortion of the substrate, suitably about 250 N/cm or less, and preferably about 70 N/cm. Substrate speeds through the rotogravure printing process can be from about 1 meter per minute or less to about 1500 meters per minute or more, desirably from about 1 meter per minute to about 300 meters per minute, allowing the printing to be accomplished on-line during substrate manufacture or subsequently during converting.

A surprising result occurs when an air stream is applied against the gravure cylinder between the doctor blade and the nip formed by the gravure cylinder and the impression roller. In this event, it appears from SEM photographs that the receptor solution is transferred to the substrate from the land areas between the engraved cells rather than from the engraved cells. While the inventors do not wish to be held to any particular theory of operation, it is believed that this occurs because the air flow depresses the level of the receptor solution in the cells below the land areas, the small amount of receptor solution remaining on the land areas partially dries, and is then transferred to the substrate as the substrate passes between the gravure cylinder and the impression roller.

### Test Procedures

The following test procedures are used to determine the effectiveness of the printing process by evaluating diffraction strength and/or print coverage.

Enzyme-Based Test for Diffraction

Cut small pieces (˜0.5 cm square) of a printed diagnostic film sample, and place face up on a glass slide.

Prepare a 5 μg/ml solution of HRP-labeled (horseradish peroxidase) anti-mouse IgG antibody (Cat. No. 14-13-06, available from Kirkegaard & Perry Laboratories Inc. of Gaithersburg, Md.) in phosphate buffer saline (PBS), for example 0.1M sodium phosphate, 0.15M sodium chloride, pH 7.2 (Cat. No. 28372, available from Pierce). Also, prepare a 10:1 v/v mixture of tetramethyl benzidine (TMB) (Cat. No. 50-85-05, available under the ONE-COMPONENT brand from Kirkegaard & Perry Laboratories Inc. of Gaithersburg, Md.) and TMB Membrane Enhancer solution (Cat. No. 50-77-01, available from Kirkegaard & Perry Laboratories Inc. of Gaithersburg, Md.) in PBS.

Place 50 μl of the HRP-labeled antibody solution on top of each of the printed diagnostic film samples, and allow the samples to incubate undisturbed for 30 minutes at room temperature. After 30 minutes, rinse the printed diagnostic film samples with a wash solution (diluted ten-fold in distilled water from 10× stock solution, Cat. No. 50-63-01, available from Kirkegaard & Perry Laboratories Inc. of Gaithersburg, Md.) followed by rinsing with distilled water. Wick excess liquid from the samples, and dry the samples with a filtered air stream.

Place 50 μL of the TMB mixture on top of each printed diagnostic film sample, and allow the samples to incubate undisturbed for 5 minutes. After 5 minutes, rinse the samples with distilled water. Wick excess liquid from the samples, and dry the samples with a filtered air stream.

Observe the samples for diffraction caused by patterned TMB precipitate using a laser (Model 106-1, available from Spectra-Physics, Inc. of Eugene, Oreg.). Strength of the diffraction pattern is measured by counting the number of diffraction orders that are generated. Generally speaking, diffraction in the range of one to two orders is considered to be weak diffraction, diffraction in the range of two to three orders is considered to be moderate diffraction, and diffraction of more than three orders is considered to be strong diffraction. Also, the samples are evaluated under a microscope for patterned blue staining that indicates the presence of patterned antibody. Printing coverage is measured by visually estimating the percentage of the total cell area that appears blue on the printed sample.

Particle-Based Assay Test for Diffraction

Cut 8 small pieces (˜0.9 cm square) of a printed diagnostic film sample, rinse with distilled water, air dry, and place face up in a finely recessed 8-well standardized setup.

Prepare a suspension of 0.3 μm size carboxylated beads (available as Catalog No. PCO2N from Bangs Laboratories of Fishers, Ind.) coupled to C-reactive protein monoclonal antibody (Cat. No. A58110228P, available from Biospacific of Emeryville, Calif.) in distilled water. Resuspend the particles in diluent consisting of PBS buffer and 0.3% t-octylphenoxypolyethoxyethanol surfactant (CAS No. 9002-93-1, available as TRITON X-100 from Sigma-Aldrich of St. Louis, Mo.) by placing the desired volume of particles in an Eppendorf centrifuge tube and centrifuge for 6 minutes. Thereafter, discard the supernatant storage buffer, and replace with an equal volume of the PBS buffer solution containing the surfactant. A typical concentration of particles is 1.25% solids. Mix the microparticle suspension until fully dispersed by mixing in a vortex mixer, using a sonic bath with ice, and then mixing in a vortex mixer again.

Prepare an antigen solution from blood containing ethylene diamine tetraacetic acid (EDTA) and spiked with 50 μg/ml C-reactive protein (CRP) as an analyte (EDTA blood available from Interstate Plasma of Memphis, Tenn.). Prepare a control sample by treating undiluted spiked blood with magnetic CRP-removing beads (prepared using Biotinylation kit No. 21430 available from Pierce and Dynalbeads M-280 Streptavidin available from Dynal A. S. of Oslo, Norway) to reduce and possibly eliminate the CRP in the blood. Then dilute both the CRP-containing blood and the filtered control blood samples 1:9 v/v with PBS buffer containing 0.3% TRITON X-100.

Add 34 μl of diluted blood to each sample well, using both antigen-containing blood and filtered control blood, and incubate for 5 minutes at room temperature. Next, add 11 μl of microparticle suspension to all samples, both antigens and controls. Incubate at room temperature for an additional 10 minutes.

After this time, place a wicking agent disk with a 1.6 mm diameter hole in the center (Whatman 8 micron pore size nitrocellulose, available from Millipore of Bedford, Mass.) on top of each sample to wick away excess particles and solution. Immediately thereafter, measure diffraction using a laser (Model 106-1 available, from Spectra-Physics, Inc. of Eugene, Oreg.). Strength of the diffraction pattern is measured by counting the number of diffraction orders that are generated.

Next, observe samples under microscope, initially at 100× magnification, and record percent coverage, as well as other observations such as film formation that could result from insufficient wicking during the test, aggregation of particles that could result in a poor diffraction pattern, or clean patterning that will result in a good diffraction pattern. Percent coverage is measured by visually estimating the percentage of the total cell area that shows binding of coupled particles to the printed pattern within the 1.6 mm viewing area.

### EXAMPLES

This invention is further illustrated by the following examples, which are not to be construed in any way as imposing limitations upon the scope thereof. On the contrary, it is to be clearly understood that resort may be had lo various other embodiments, modifications, and equivalents thereof, which after reading the description herein, may suggest themselves to those skilled in the art without departing from the spirit of the present invention.

Receptor solution was prepared by diluting 20 mg of antibody (monoclonal antibody to C-reactive protein (CRP), available as Cat. No. A58040136P from Biospacific of Emeryville, Calif.) in 9.0 ml of PBS. It is important to note that the CRP antibody must not be in Tris or other amine-containing buffers that would interfere with the reaction between the antibody and the protein. If this is the case, use MICROCON tubes (available from Millipore of Bedford, Mass.) to exchange the buffer solution.

Next, 1.2 mM stock solution of a disulfide modifying reagent (available as Sulfo-LC-SPDP from Pierce of Rockford, Ill.) in distilled water (e.g., 1.3 mg Sulfo-LC-SPDP in 2.07 ml distilled water) was prepared. Thereafter, 1 ml of the Sulfo-LC-SPDP stock solution was added to the CRP antibody solution and mixed well to thiolate the antibody solution. The thiolated antibody solution was incubated undisturbed for 60 minutes at room temperature.

During this time, a 25-ml desalting column (e.g. D-Salt Polyacrylamide Column available from Pierce of Rockford, Ill.) was equilibrated with 5 bed volumes (125 mL) of PBS buffer. After incubation, the sample was applied to the top of the column. After dripping had stopped, elution with PBS was begun and antibody-positive fractions were collected in a collection tube (available as EPPENDORF tubes distributed by Brinkman Instruments, Inc. of Westbury, N.Y.). The antibody content was monitored using a protein staining reagent (available as COOMASSE PLUS Protein Detection Reagent from Pierce of Rockford, Ill.) by mixing 50 μl of eluent with 50 μl of the protein staining reagent. The presence of antibody is indicated by a blue color in the solution.

The eluent was concentrated using concentrating tube, (available as MICROSEP tubes 30K MWCO from Pall Gelman of Ann Arbor, Mich.) to a concentration of 0.8 mg/ml. Absorbance of the concentrated eluent was monitored with a spectrophotometer at 280 nm to determine the concentration by the Beer-Lambert Law:

A=(a_{λ})(b)(c),

where A is the measured absorbance, a_{λ} is a wavelength-dependent absorptivity coefficient, b is the path length, and c is the analyte concentration.

A flow modifier was added to a portion of the antibody solution. Glycerol (Cat. No. 56-81-5, available from Aldrich of Milwaukee, Wis.) was used at a 3% level for printing some of the samples to vary the flow characteristics of the antibody solution. Viscosity data in centipoise (cp) for water, CRP antibody solution, and CRP antibody solution containing 3% glycerol is shown in Table 1.

TABLE 1
Viscosity Data for Receptor Solutions

| RECEPTOR SOLUTION | VISCOSITY(cp) @ 25° C. |
|---|---|
| WATER | 0.997 |
| CRP ANTIBODY | 0.983 ± 0.070 |
| CRP ANTIBODY + 3% GLYCEROL | 1.140 ± 0.067 |

The substrate was a gold-coated MYLAR PET film (available from CP Films of CA) having a thickness of 0.013 cm and a surface resistivity of greater than or equal to 13 ohms per square cut into 5 inch by 10 inch pieces. Several surface treatments were evaluated including application of either 0.01% Trilton or 5 mg/ml beta-casein to the metal-coated side of the film to increase surface energy and wettability. The surface treatments were applied by immersing the sheet face down in the treatment solution for 10 minutes. After this time, the film was removed, rinsed with distilled water, and then dried under a stream of filtered air.

A 6-inch wide rotogravure cylinder engraved with closed cells at 157 lines per centimeter (lpc) was used to print the thiolated antibody solution, i.e., the receptor solution, on to the gold-coated MYLAR PET film. The 157 lpc rotogravure cylinder, or anilox cylinder (obtained from Armotek Industries, Inc. of Palmyra, N.J.), was engraved according to the following specifications:

| | |
|---|---|
| Face | 6 |
| Design | 400 L/S |
| Screen count | 400 |
| Cell depth | 12 micron |
| Cell width | 51 micron |
| Cell wall X | 13 micron |
| Cell wall Y | 15 micron |
| Cylinder Diameter | 12.13 cm |
| T.I.R. | 0.0013 cm |
| Cell height | 81 microns |

Thus, the 0.8 mg/ml solution of thiolated antibody for C-reactive protein in PBS was placed in a receptor solution basin that was used to apply the receptor solution to the patterned rotogravure cylinder. The patterned rotogravure cylinder was arranged such that its face was immersed in the receptor solution basin. A plastic doctor blade was used to remove excess receptor solution from the gravure cylinder.

A direct, roll-to-roll configuration was used, as shown in FIG. 1. The surface treated gold-coated MYLAR film was fed between the gravure cylinder and the impression roll that were rotating in opposite directions in an orientation that exposed the gold side to the patterned or anilox cylinder. The linear nip force that presses on the substrate between the gravure cylinder and the impression roll was adjusted between 125 and 209 N/cm. The rotary speed of the gravure cylinder and the impression roll, or line speed, was also varied in some trials. The doctor blade, pivot-based with an air cylinder to provide pressure against the gravure cylinder, was adjusted to minimize smearing of the receptor solution on the land areas between the rotogravure cells. Some of the samples were prepared using a flow of air applied against the gravure cylinder between the doctor blade and the nip formed by the gravure cylinder and the impression roller. Some of the samples were prepared using filtered air at room temperature (˜25° C.) to dry the samples and others were dried using filtered air at 38° C. Samples were then rinsed with distilled water and dried under an air stream before testing.

A total of 32 samples were produced according to the process conditions specified in Table 2.

TABLE 2
Rotogravure Process Settings and Test Results

| | | | | | | Diffrac- | |
|---|---|---|---|---|---|---|---|
| | Nip | | Gly- | Air | Heat | tion | Blue |
| | Force | Surface | cerol | On | @ | Test | Stain |
| # | (N/cm) | treatment | (%) | Roll | 38° C. | w/Enzyme | Test |
| 1 | 125 | Beta Casein | 0 | No | No | 2 | Strong |
| 2 | 125 | Beta Casein | 0 | No | No | 3 | Strong |
| 3 | 125 | Triton X-100 | 0 | No | No | 0 | No |
| 4 | 125 | Triton X-100 | 0 | No | No | 0 | No |
| 5 | 125 | Beta Casein | 0 | Yes | No | 3 | Strong |
| 6 | 209 | Beta Casein | 0 | Yes | No | <1 | Faint |
| 7 | 125 | Triton X-100 | 0 | Yes | No | 0 | No |
| 8 | 209 | Triton X-100 | 0 | Yes | No | 0 | Very |
| | | | | | | | Faint |
| 9 | 125 | None | 0 | No | No | 0 | Very |
| | | | | | | | Faint |
| 10 | 125 | None | 0 | Yes | No | 0 | No |
| 11 | 125 | Beta Casein | 0 | No | Yes | 0 | Strong |
| 12 | 125 | Triton X-100 | 0 | No | Yes | 0 | No |
| 13 | 125 | Beta Casein | 3 | No | No | <1 | Faint |
| 14 | 125 | Beta Casein | 3 | No | No | <2 | Faint |
| 15 | 125 | Triton X-100 | 3 | No | No | 0 | No |
| 16 | 125 | Triton X-100 | 3 | No | No | 0 | No |
| 17 | 125 | Beta Casein | 3 | Yes | No | 4 | Strong |
| 18 | 209 | Beta Casein | 3 | Yes | No | <4 | Strong |
| 19 | 125 | Triton X-100 | 3 | Yes | No | 0 | No |
| 20 | 209 | Triton X-100 | 3 | Yes | No | 0 | No |
| 21 | 125 | None | 3 | No | No | 0 | No |
| 22 | 125 | None | 3 | Yes | No | 0 | No |
| 23 | 125 | Beta Casein | 3 | Yes | Yes | <5 | Strong |
| 24 | 125 | Triton X-100 | 3 | Yes | Yes | 0 | No |
| 25 | 125 | Beta Casein | 0 | No | No | <3 | Strong |
| 26 | 125 | Beta Casein | 0 | No | No | <1 | Faint |
| 27 | 209 | Beta Casein | 0 | No | No | 0 | No |
| 28 | 209 | Beta Casein | 3 | No | No | <3 | Strong |
| 31 | 125 | Beta Casein | 3 | Yes | No | 0 | No |
| 32 | 209 | Beta Casein | 3 | No | No | 0 | No |

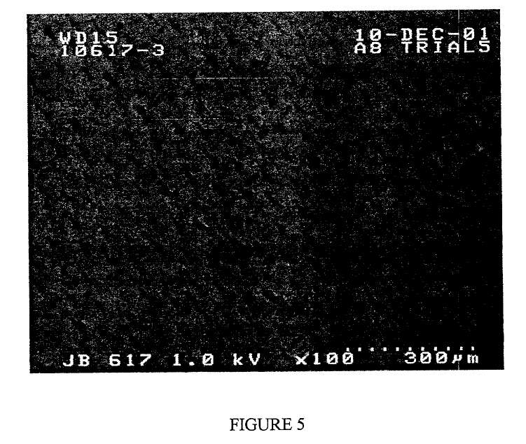

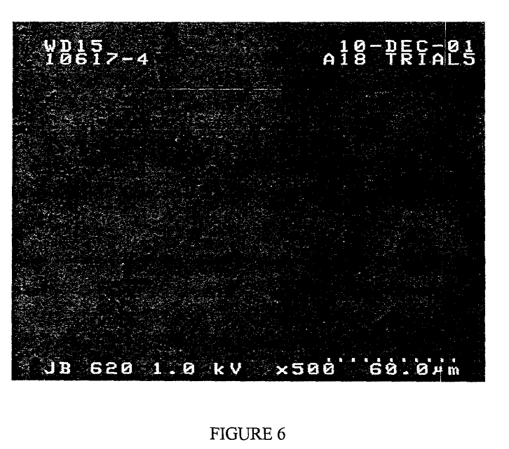

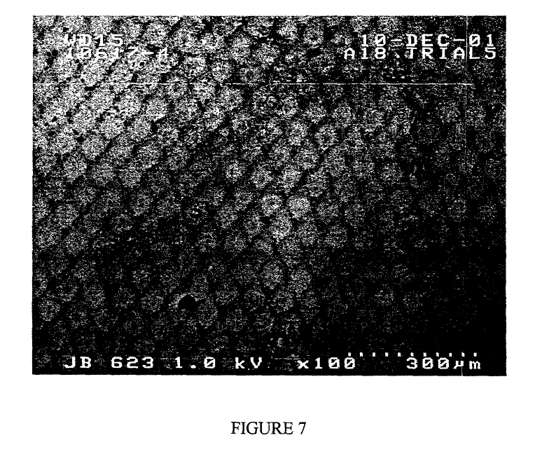

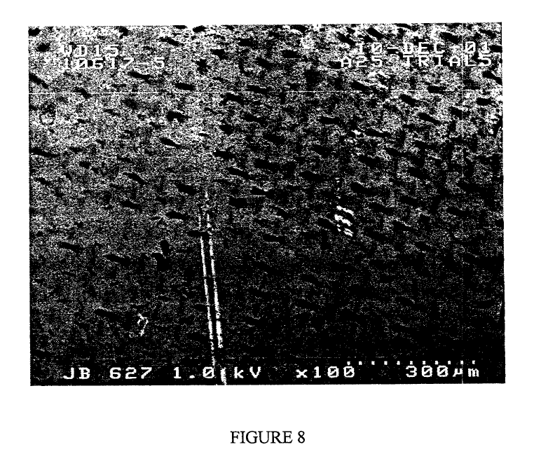

Tests for printing effectiveness consisted of either enzyme-based staining to indicate patterned antibody (see Table 2), and particle-based assays specific for C-reactive protein (see Table 3). Photomicrographs of samples 8, 18, and 25 after enzyme staining are shown in FIGS. 5-8.

TABLE 3
Test Results for Particle-based Assay Test for Diffraction

| | |
|---|---|
| % Coverage | Diffraction |

| # | Antigen | Control | Antigen | Control |
|---|---|---|---|---|
| 1 | 0 | 0 | 0 | 0 |
| 2 | 0 | 0 | 0 | 0 |
| 5 | 25 | 40 | <1 | <1 |
| 5 | 50 | 50 | <5 | <3 |
| 6 | 40 | 0 | <1 | 0 |
| 6 | 30 | 25 | <2 | <1 |
| 8 | 0 | 0 | <1 | 0 |
| 8 | 25 | 0 | <1 | 0 |
| 9 | 0 | 0 | 0 | 0 |
| 11 | 0 | 0 | 0 | 0 |
| 13 | 20 | 0 | 0 | 0 |
| 14 | 0 | 0 | 0 | 0 |
| 17 | 0 | 0 | 0 | 0 |
| 18 | 0 | 0 | 1 | 0 |
| 18 | 0 | 0 | 1 | 0 |
| 23 | 15 | 0 | 0 | 0 |
| 23 | 25 | 0 | 1 | <1 |
| 25 | 0 | 0 | 0 | 0 |
| 25 | 15 | 0 | 5 | <1 |
| 26 | 15 | 0 | 0 | 0 |
| 28 | 0 | 0 | 0 | 0 |

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. A method for preparing a diffraction-based diagnostic biosensor film comprising the steps of:
a) providing a receptor solution comprising a receptor and a carrier fluid,
b) applying the receptor solution to a printing cylinder having a longitudinal axis and an engraved pattern of cells, each cell having a width, height, and depth for acceptance of the receptor solution, the printing cylinder being rotated about the longitudinal axis,
c) transferring the receptor solution from the rotating printing cylinder to a substrate, and,
d) drying the printed substrate,
wherein the dried receptor forms a pattern comprising individual printed areas having a center-to-center spacing ranging from about 0.1 microns to about 100 microns.

2. The method of claim 1 wherein the receptor comprises a protein.

3. The method of claim 1 wherein the receptor comprises an antibody.

4. The method of claim 1 wherein the receptor is selected from the group consisting of nucleic acids, peptides, small organic molecules and combinations thereof.

5. The method of claim 1 wherein the carrier fluid comprises water.

6. The method of claim 1 wherein the carrier fluid comprises aqueous buffer solution.

7. The method of claim 1 wherein the carrier fluid comprises phosphate buffered saline.

8. The method of claim 1 wherein the receptor solution has a viscosity less than about 10 centipoise.

9. The method of claim 1 wherein the receptor solution has a viscosity less than about 2 centipoise.

10. The method of claim 1 wherein the receptor solution further comprises receptor at a concentration of at least 0.1 mg/ml.

11. The method of claim 1 wherein the receptor solution further comprises a flow modifier.

12. The method of claim 11 wherein the flow modifier is glycerol.

13. The method of claim 1 wherein only a fraction of the receptor solution within a cell is transferred from the rotating printing cylinder to the substrate.

14. The method of claim 1 wherein the substrate comprises a thermoplastic film.

15. The method of claim 14 wherein the substrate further comprises a metal coating.

16. The method of claim 15 wherein the metal coating comprises gold.

17. The method of claim 15 wherein the receptor solution is applied to the metal coating of the thermoplastic film.

18. The method of claim 1 further comprising the step of applying surface treatment to the substrate prior to transferring the receptor solution from the rotating printing cylinder to the substrate.

19. The method of claim 18 wherein the surface treatment comprises a surfactant.

20. The method of claim 18 wherein the surface treatment comprises Corona discharge.

21. The method of claim 18 wherein the surface treatment comprises a protein.

22. The method of claim 21 wherein the protein comprises beta-caseine.

23. The method of claim 1 further comprising the step of directing a stream of air at the surface of the rotating printing cylinder prior to application of the receptor solution to the substrate.

24. The method of claim 1 further comprising the step of rinsing the printed substrate prior to drying the printed substrate.

25. The method of claim 1 wherein the drying step further comprises air drying of the receptor solution on the printed substrate at ambient conditions.

26. The method of claim 1 wherein the individual printed areas forming the pattern have a center-to-center spacing ranging from about 10 microns to about 75 microns.

27. The method of claim 1 wherein the individual printed areas forming the pattern measure from about 0.1 microns across to about 70 microns across.

28. The method of claim 27 wherein the individual printed areas forming the pattern measure from about 1 micron across to about 50 microns across.

29. The method of claim 1 wherein the contact angle of the receptor solution with respect to the surface of the substrate is less than the contact angle of the receptor solution with respect to the surface of the gravure cylinder.

30. The method of claim 29 wherein the contact angle of the receptor solution with respect to the surface of the substrate is from about 5° to about 90°.

31. The method of claim 29 wherein the contact angle of the receptor solution with respect to the surface of the substrate is from about 100 to about 80°.

32. The method of claim 29 wherein the contact angle of the receptor solution with respect to the surface of the substrate is from about 30° to about 70°.

33. The diffraction-based biosensor film made according to the process of claim 1.

34. A method for preparing a diagnostic biosensor film comprising the steps of:
a) providing a receptor solution comprising a receptor and a carrier fluid,
b) applying the receptor solution to a printing cylinder having a longitudinal axis and an engraved pattern of cells, each cell having a width, height, and depth for acceptance of the receptor solution, the printing cylinder being rotated about the longitudinal axis,
c) transferring the receptor solution from the rotating printing cylinder to a substrate, and
d) drying the printed substrate.

35. The diagnostic biosensor film made according to the process of claim 34.
